(19) United States
(12) Patent Application Publication
(10) Pub. No.: US 2023/0148815 A1
(43) Pub. Date: May 18, 2023

(54) SUCTION DEVICE AND SUCTION FORCE ADJUSTMENT METHOD THEREOF

(71) Applicant: Aspect Microsystems Corp., Taipei City (TW)

(72) Inventors: Mingshun Shih, Taipei City (TW); Jung-Fu Liao, Taipei City (TW); Jih-Chang Chen, Taipei City (TW)

(73) Assignee: Aspect Microsystems Corp., Taipei City (TW)

(21) Appl. No.: 17/983,346

(22) Filed: Nov. 8, 2022

(30) Foreign Application Priority Data
Nov. 18, 2021 (TW) 110143005

(51) Int. Cl. A47L 9/28; A47L 9/04; A47L 9/00; A47L 9/19; H04R 1/08

(52) U.S. Cl. CPC A47L 9/2821; A47L 9/009; A47L 9/19; A47L 9/0411; A47L 9/0477; A47L 9/2826; A47L 9/2831; A47L 9/2842; A47L 9/2847; A47L 9/2857; H04R 1/08; A47L 2201/06

(57) ABSTRACT

A suction device and a suction force adjustment method thereof are provided. A detecting device collects sound generated when the suction device executes a suction operation to obtain characteristics of a sound signal. The detecting device determines a clogging degree of a filter disposed on an exhaust vent of a suction unit, an airflow velocity in a suction pipe, a material of the suctioned surface, and a degree of closure between a suction port of the suction device and the suctioned surface according to the characteristics of the sound signal. A control host adjusts a suction force of the suction unit or adjusts the degree of closure between the suction port of the suction device and the suctioned surface according to a detected result of the detecting device, and provides warning information for cleaning or replacing the filter.

### CROSS-REFERENCE TO RELATED APPLICATION

This application claims the priority benefit of Taiwan Application Serial No. 110143005, filed on Nov. 18, 2021. The entirety of the above-mentioned patent application is hereby incorporated by reference herein and made a part of this specification.

### BACKGROUND

### Technical Field

The disclosure relates to an electronic device, and more particularly to a suction device and a suction force adjustment suction force adjustment method according to characteristics of a sound signal.

### Description of Related Art

With the development of technology, vacuum cleaners or sweeping robots that can automatically execute vacuuming and automatic charging functions have become quite common. When such cleaning tools encounter planes with different materials during the cleaning process, the cleaning tools cannot change the cleaning settings, such as adjusting the suction force or the rotational speed of the rolling brush, according to the material of the plane, which may cause issues such as poor cleaning effect or excessive power consumption.

### SUMMARY

The disclosure provides a suction device and a suction force adjustment method thereof, which can effectively improve the suction efficiency of the suction device.

The suction device of the disclosure includes a control host, a suction unit, a suction pipe, and a detecting device. The suction unit is connected to the suction pipe and provides a suction force in the suction pipe to suction a suctioned surface. The detecting device collects sound generated when the suction device executes a suction operation, and generates a detected result according to a characteristic of the sound signal obtained by sound collection. The control host is coupled to the suction unit and the detecting device, and adjusts the suction force of the suction unit or a degree of closure between a suction port of the suction device and the suctioned surface according to the detected result.

In an embodiment of the disclosure, the detecting device determines a characteristic of the suctioned surface, the degree of closure between the suction port of the suction pipe and the suctioned surface, and a suction force condition of the suction unit according to the characteristic of the sound signal to generate the detected result. The control host controls the suction force of the suction unit or adjusts the degree of closure between the suction port of the suction pipe and the suctioned surface according to at least one of the characteristic of the suctioned surface, the degree of closure between the suction port of the suction pipe and the suctioned surface, and the suction force condition of the suction unit.

In an embodiment of the disclosure, the characteristic of the suctioned surface includes a material of the suctioned surface.

In an embodiment of the disclosure, the characteristic of the sound signal includes at least one of sound of air flowing through the suction pipe, sound of air flowing through a gap between the suction port of the suction pipe and the suctioned surface, and sound of the suction unit operating.

In an embodiment of the disclosure, the suction device further includes a rolling unit and a moving wheel. The rolling unit contacts the suctioned surface and rolls. The characteristic of the sound signal includes sound of a motor driving the rolling unit operating, sound when the rolling unit contacts the suctioned surface and rolls, and sound of the moving wheel rotating on the suctioned surface. The control host controls at least one of a rolling speed of the rolling unit, a rolling direction of the rolling unit, a degree of fit between the rolling unit and the suctioned surface, and rotation of the moving wheel according to the detected result.

In an embodiment of the disclosure, the suction device further includes a storage unit storing multiple preset sound characteristics. The detecting device compares the preset sound characteristics with the characteristic of the sound signal obtained by sound collection to generate the detected result. The control host controls the suction force of the suction unit or adjusts the degree of closure between the suction port of the suction pipe and the suctioned surface according to the detected result.

In an embodiment of the disclosure, the suction device further includes a filter disposed on an exhaust vent of the suction unit. The characteristic of the sound signal may further include at least one of sound of air flowing through the suction pipe, sound of air flowing through the filter, and sound of the suction unit operating. The detecting device determines a clogging degree of the filter, an airflow velocity in the suction pipe, and a suction force condition of the suction unit according to a comparison result between the preset sound characteristics and the characteristic of the sound signal to generate the detected result. The control host further controls the suction force of the suction unit or adjusts the degree of closure between the suction port of the suction pipe and the suctioned surface according to at least one of the clogging degree of the filter, the airflow velocity in the suction pipe, and the suction force condition of the suction unit.

In an embodiment of the disclosure, the control host further provides warning information for cleaning or replacing the filter according to the clogging degree of the filter.

In an embodiment of the disclosure, the detecting device includes a sound collecting unit disposed in the suction pipe, and the sound collecting unit is a microphone or a microphone array.

In an embodiment of the disclosure, the detecting device further adjusts an interval period of sound collection by the detecting device, a sampling frequency of sound collection, and a sampling time length of sound collection each time according to a working parameter of the suction unit.

The disclosure also provides a suction force adjustment method of a suction device. The suction device includes a suction unit and a suction pipe. The suction unit is connected to the suction pipe and provides a suction force in the suction pipe to suction a suctioned surface. The suction force adjustment method of the suction device includes the following steps. Sound generated when the suction device executes a suction operation is collected, and a detected result is generated according to a characteristic of a sound signal obtained by sound collection. The suction force of the suction unit is controlled or a degree of closure between a suction port of the suction pipe and the suctioned surface is adjusted according to the detected result.

In an embodiment of the disclosure, the suction force adjustment method of the suction device includes determining a characteristic of the suctioned surface, the degree of closure between the suction port of the suction pipe and the suctioned surface, and a suction force condition of the suction unit according to the characteristic of the sound signal to generate the detected result, and controlling the suction force of the suction unit or adjusting the degree of closure between the suction port of the suction pipe and the suctioned surface according to at least one of the characteristic of the suctioned surface, the degree of closure between the suction port of the suction pipe and the suctioned surface, and the suction force condition of the suction unit.

In an embodiment of the disclosure, the characteristic of the suctioned surface includes a material of the suctioned surface.

In an embodiment of the disclosure, the characteristic of the sound signal includes at least one of sound of air flowing through the suction pipe, sound of air flowing through a gap between the suction port of the suction pipe and the suctioned surface, and sound of the suction unit operating.

In an embodiment of the disclosure, the suction device further includes a rolling unit and a moving wheel. The characteristic of the sound signal includes sound of a motor driving the rolling unit to roll operating, sound when the rolling unit contacts the suctioned surface and rolls, and sound of the movement wheel rotating on the suctioned surface. The suction force adjustment method of the suction device includes controlling at least one of a rolling speed of the rolling unit, a rolling direction of the rolling unit, a degree of fit between the rolling unit and the suctioned surface, and rotation of the moving wheel according to the detected result.

In an embodiment of the disclosure, the suction force adjustment method of the suction device includes controlling the suction force of the suction unit or adjusting the degree of closure between the suction port of the suction pipe and the suctioned surface according to a comparison result between the preset sound characteristics and the characteristic of the sound signal.

In an embodiment of the disclosure, the suction force adjustment method of the suction device includes adjusting an interval period of sound collection, a sampling frequency of sound collection, and a sampling time length of sound collection each time according to a working parameter of the suction unit.

Based on the above, the embodiment of the disclosure may collect the sound generated when the suction device executes the suction operation to obtain the characteristics of the sound signal, and determine the suction force condition of the suction unit, the degree of closure between the suction port of the suction pipe and the suctioned surface, and the characteristics of the suctioned surface according to the characteristics of the sound signal, so as to adjust the suction force of the suction device, adjust the rolling speed and direction of the rolling unit, and adjust of the degree of closure between the suction port of the suction pipe and the suctioned surface, thereby effectively improving the suction efficiency of the suction device to reduce power consumption.

### BRIEF DESCRIPTION OF THE DRAWINGS

FIG. 1 is a schematic diagram of a suction device according to an embodiment of the disclosure.

FIG. 2 is a schematic diagram of a suction device according to another embodiment of the disclosure.

FIG. 3 is a flowchart of a suction force adjustment method of a suction device according to an embodiment of the disclosure.

### DETAILED DESCRIPTION OF DISCLOSED EMBODIMENTS

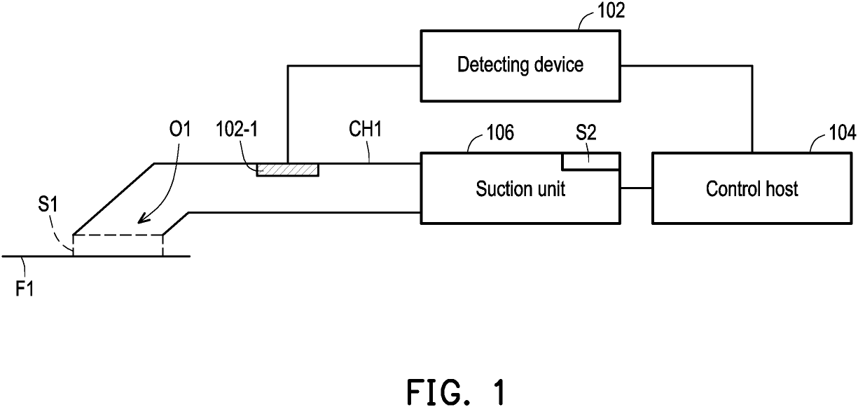

FIG. 1 is a schematic diagram of a suction device according to an embodiment of the disclosure. Please refer to FIG. 1. The suction device may be, for example, a vacuum cleaner or a sweeping robot, but not limited thereto. The suction device may include a suction pipe CH1, a detecting device 102, a sound collecting unit 102-1, a control host 104, and a suction unit 106. The control host 104 is coupled to the detecting device 102 and the suction unit 106. In addition, the suction unit 106 is connected to the suction pipe CH1. In the case where the suction device is the vacuum cleaner, the suction pipe CH1 may include a passage from a suction port O1 of a suction head of the vacuum cleaner to the suction unit 106. In the case where the suction device is the sweeping robot, the suction pipe CH1 may, for example, include a passage from the suction port O1 for dust suction to the suction unit 106.

The suction unit 106 may provide a suction force in the suction pipe CH1 to suction a suctioned surface F1. The suction unit 106 may include, for example, a fan motor, but not limited thereto. The detecting device 102 includes the sound collecting unit 102-1, and the detecting device 102 collects sound generated when the suction device executes a suction operation to obtain characteristics of a sound signal. In the embodiment, the detecting device 102 may, for example, be a processor for sound analysis. The sound collecting unit 102-1 is disposed in the suction pipe CH1, and the sound collecting unit 102-1 may be implemented by, for example, a microphone or a microphone array. It is worth noting that in other embodiments, the detecting device 102 and the sound collecting unit 102-1 may also be integrated into one detecting device, which is disposed in the suction pipe CH1 or at other positions on the suction device. The control host 104 may control the suction force of the suction unit 106 according to a detected result provided by the detecting device 102, so as to appropriately adjust the suction efficiency of the suction device, thereby adjusting a degree of closure between the suction port O1 and the suctioned surface F1 to reduce power consumption. For example, when the detecting device 102 determines that there is no gap space S1 between the suction port O1 and the suctioned surface F1 according to the characteristics of the sound signal, that is, when the suction port O1 is completely clogged by the suctioned surface F1 (for example, in the case where the suctioned surface F1 is a long pile carpet, when the suction port O1 is clogged by the pile of the long pile carpet), the control host 104 may mitigate the clogging of the suction port O1 through reducing the suction force of the suction unit 106, so as to reduce the degree of closure between the suction port O1 and the suctioned surface F1, thereby reducing power consumption. The detecting device 102 directly collects the sound generated when the suction device executes the suction operation, instead of collecting sound signals by actively emitting specific sound waves and then receiving the reflected sound waves.

Further, the characteristics of the sound signal may include, for example, at least one of the sound of air flowing through the suction pipe CH1, the sound of air flowing through a gap (that is, the gap space S1) between the suction port O1 of the suction pipe CH1 and the suctioned surface F1, and the sound of the suction unit 106 operating. The detecting device 102 may determine characteristics of the suctioned surface F1 according to the characteristics of the sound signal, and control the suction force of the suction unit 106 according to the characteristics of the suctioned surface F1, wherein the characteristics of the suctioned surface F1 may include, for example, the material of the suctioned surface F1. For example, the suctioned surface F1 may be, for example, a carpet with different materials or styles, such as a long pile carpet or a short pile carpet, or, for example, a wooden floor, a plastic floor, a marble floor, a cement floor, etc.

When the suction device performs the suction operation on the suctioned surface F1, air may flow through the gap between the suction port O1 of the suction pipe CH1 and the suctioned surface F1 to generate wind shear sound, and the wind shear sound corresponding to the gap with different sizes is also different. Therefore, the detecting device 102 may determine the characteristics of the suctioned surface F1 and an airflow velocity in the suction pipe according to the wind shear sound, and provide the detected result to the control host 104 to control the suction force of the suction unit 106. The gap between the suction port O1 of the suction pipe CH1 and the suctioned surface F1 may vary due to the material of the suctioned surface and the degree of closure. For example, for a hard floor with a smoother surface (such as a plastic floor), the gap between the suction port O1 of the suction pipe CH1 and the suctioned surface F1 is larger. For another example, since the pile of the pile carpet may clog the suction port O1 of the suction pipe CH1, there is a smaller gap between the suction port O1 of the suction pipe CH1 and the pile carpet than the hard floor. For another example, the long pile carpet has longer pile than the short pile carpet, which may clog the suction port O1 of the suction pipe CH1 to a greater extent, so there is an even smaller gap between the suction port O1 of the suction pipe CH1 and the long pile carpet.

In addition, in the embodiment, the suction device may further include a filter S2, which may be disposed on an exhaust vent of the suction unit 106. The filter S2 may include multiple gaps for air to flow through, and the characteristics of the sound signal may also include the sound of air flowing through the gaps of the filter S2. The detecting device 102 may judge at least one of the characteristics of the suctioned surface F1, the degree of closure between the suction port of the suction pipe CH1 and the suctioned surface F1, a suction force condition of the suction unit 106, a clogging degree of the filter S2, and the airflow velocity in the suction pipe according to the characteristics of the recorded sound signal, and provide the detected result to the control host 104, so that the control host 104 may control the suction force of the suction unit 106 or adjust the degree of closure between the suction port O1 of the suction pipe CH1 and the suctioned surface F1 accordingly. In some embodiments, the control host 104 may also provide warning information for cleaning or replacing the filter S1.

In some embodiments, the detecting device 102 may also adjust an interval period of sound collection by the detecting device 102, a sampling frequency of sound collection (for example, sound collection for sound in a specific frequency range), and a sampling time length of sound collection each time according to a working parameter of the suction unit 106. For example, the working parameter of the suction unit 106 may be, for example, a rotational speed of a suction motor or an operation time of the suction unit 106, but not limited thereto. For example, when the rotational speed of the suction motor is higher, that is, the suction force of the suction unit 106 is stronger, the detecting device 102 may shorten the interval period of sound collection, increase the sampling frequency of sound collection to obtain more accurate sound in higher frequency bands, and appropriately change the sampling time length of sound collection each time to obtain more accurate information, thereby improving the determination accuracy of the detecting device 102.

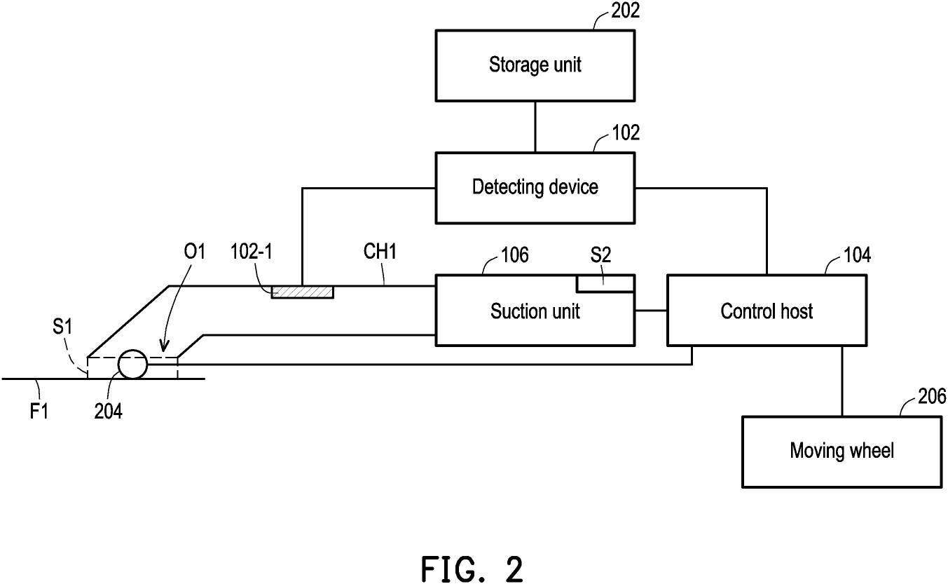

FIG. 2 is a schematic diagram of a suction device according to another embodiment of the disclosure. In the embodiment, the suction device may further include a storage unit 202, a rolling unit 204, and a moving wheel 206. The storage unit 202 is coupled to the detecting device 102, and the rolling unit 204 is coupled to the control host 104. In the case where the moving wheel 206 is driven by the control host 104, the moving wheel 206 may be coupled to the control host 104. The storage unit 202 may store multiple preset sound characteristics. The preset sound characteristics may include, for example, sound characteristics corresponding to different suctioned surfaces F1 (for example, the gap space S1 between the suctioned surface F1 with different materials and the suction port O1 is different, so different suctioned surfaces F1 may correspond to different preset sound characteristics), sound characteristics corresponding to the suction force conditions of different suction units 106, sound characteristics corresponding to the filter S1 with different clogging degrees, sound characteristics corresponding to the motor with different rotational speeds, sound characteristics corresponding to the rolling unit 204 contacting different suctioned surfaces F1 when rolling, sound characteristics corresponding to the moving wheel 206 rotating on different suctioned surfaces F1, and other sound characteristics that may be caused when the suction device operates. The detecting device may compare the preset sound characteristics stored in the storage unit 202 with the characteristics of the sound signal at that time to generate the detected result, so that the control host 104 may control the suction force of the suction unit 106, adjust the degree of closure between the suction port O1 of the suction pipe CH1 and the suctioned surface F1, or provide the warning information for cleaning or replacing the filter S1 according to the detected result.

In some embodiments, the control host 104 may not only adjust the suction force of the suction unit 106 to adjust the degree of closure between the suction port O1 of the suction pipe CH1 and the suctioned surface F1, but also, for example, adjust the distance between the moving wheel 206 and the bottom of the suction device to increase the distance between the bottom of the suction device and the suctioned surface F1. For example, the moving wheel 206 may include multiple wheels with different sizes, and the control host 104 may choose to drive the wheel with a larger size to increase the distance between the bottom of the suction device and the suctioned surface F1, thereby increasing the distance between the suction port O1 of the suction pipe CH1 and the suctioned surface F1, so that the degree of closure between the suction port O1 and the suctioned surface F1 may be reduced. For another example, in some embodiments, the moving wheel 206 may include a lifting mechanism. The lifting mechanism may raise the height of the suction device to increase the distance between the bottom of the suction device and the suctioned surface F1, thereby reducing the degree of closure between the suction port O1 and the suctioned surface F1.

In addition, the detecting device 102 may, for example, use artificial intelligence to compare the preset sound characteristics with the characteristics of the sound signal at that time, but not limited thereto. The preset sound characteristics stored in the storage unit 202 may be, for example, the preset sound of air flowing through the suction pipe CH1, sound of air flowing through the gap between the suction port O1 of the suction pipe CH1 and the suctioned surface F1, and sound of the suction unit 106 operating, but not limited thereto.

In the case where the suction device includes the rolling unit 204 and the moving wheel 206, the characteristics of the sound signal may further include the sound of the motor driving the rolling unit 204 operating, the sound of the rolling unit 204 rolling, the sound of the rolling unit 204 contacting the suctioned surface F1 when rolling, and the sound of the moving wheel 206 rotating on the suctioned surface F1, wherein the rolling unit 204 may be, for example, a rolling brush driven by a motor controlled by the control host 104, and the moving wheel 206 may be driven by the control host 104 to move the suction device. The sound of the rolling unit 204 is different when the rolling speed is different. The sound generated when rolling and contacting different suctioned surfaces F1 is different. For example, the friction sound between the rolling brush and the pile carpet is different from the friction sound between the rolling brush and the plastic floor. The sound of the motor of the rolling unit operating when the control host 104 drives the rolling unit 204 to roll on different suctioned surfaces F1 is different. The sound generated when the moving wheel 206 rotates on different suctioned surfaces F1 is also different. Therefore, the detecting device 102 may assist in determining the characteristics of the suctioned surface F1 according to the sound when the rolling unit 204 rolls at different speeds, the sound when the rolling unit 204 rolls and contacts the suctioned surface F1, and the sound when the moving wheel 206 rotates on the suctioned surface F1. The control host 104 may adjust the suction force of the suction unit 106 or adjust the degree of closure between the suction port O1 of the suction pipe CH1 and the suctioned surface F1 according to the sound characteristics.

In addition, since the rolling unit 204 and the moving wheel 206 may be controlled by the control host 104, the control host 104 may control a rolling contact force of the rolling unit 204 and the rotation of the moving wheel 206 according to the characteristics of the sound signal of the suctioned surface F1, so as to improve the cleaning efficiency of the suctioned surface F1, such as increasing the rolling contact force of the rolling unit 204 on the suctioned surface F1 that is less easy to clean (for example, increasing the rolling speed of the rolling brush and increasing a degree of fit between the rolling brush and the suctioned surface F1, that is, increasing the pressure of the rolling unit 204 on the suctioned surface F1, for example, in some embodiments, the rolling unit 204 may also include the lifting mechanism, and the rolling unit 204 may be brought close to the suctioned surface F1 through the lifting mechanism to increase the pressure of the rolling unit 204 on the suctioned surface F1) and reducing the rotational speed of the moving wheel 206, so as to deeply clean the suctioned surface F1.

In addition, similar to adjusting the interval period of sound collection by the detecting device 102, the sampling frequency of sound collection, and the sampling time length of sound collection each time according to the working parameter of the suction unit 106, the detecting device 102 may also adjust the interval period of sound collection, the sampling frequency of sound collection, and the sampling time length of sound collection each time according to a working parameter of the rolling unit 204. For example, in the case where the rolling unit is driven by the motor, the detecting device 102 may adjust the interval period of sound collection, the sampling frequency of sound collection, and the sampling time length of sound collection each time according to the rotational speed of the motor. For example, when the rotational speed of the motor is higher, the interval period of sound collection is shortened, a higher sampling frequency of sound collection is adopted, and the sampling time length of sound collection is adjusted.

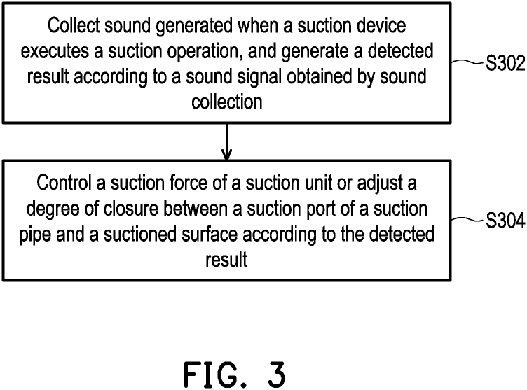

FIG. 3 is a flowchart of a suction force adjustment method of a suction device according to an embodiment of the disclosure, wherein the suction device includes, for example, a suction unit, a suction pipe, and a filter disposed on an exhaust vent. The suction unit is connected to the suction pipe, and a suction force is provided in the suction pipe to suction a suctioned surface. It can be known from the above embodiments that the suction force adjustment method of the suction device may at least include the following steps. First, sound generated when the suction device executes a suction operation is collected, and a detected result is generated according to characteristics of a sound signal obtained by sound collection (Step S302), wherein the characteristics of the sound signal may include at least one of sound of air flowing through the suction pipe, sound of air flowing through a gap between a suction port of the suction pipe and the suctioned surface, sound of the suction unit operating, and sound of air flowing through the filter, but not limited thereto. The characteristics of the sound signal may also include other sound that may be caused when the suction device operates. For example, in other embodiments, when the suction device includes a rolling unit and a moving wheel, the characteristics of the sound signal may further include sound of a motor driving the rolling unit operating, sound of the rolling unit contacting the suctioned surface when rolling, sound of the moving wheel rotating on the suctioned surface, etc. In addition, an interval period of sound collection, a sampling frequency of sound collection, and a sampling time length of sound collection each time may be adjusted according to a working parameter of the suction unit, and in some embodiments, a working parameter of the rolling unit. In addition, in some embodiments, at least one of a rolling speed of the rolling unit, a rolling direction of the rolling unit, a degree of fit between the rolling unit and the suctioned surface, and the rotation of the moving wheel may be controlled according to the characteristics of the sound signal.

Next, the suction force of the suction unit may be controlled or a degree of closure between the suction port of the suction pipe and the suctioned surface may be adjusted according to the detected result (Step S304). For example, characteristics of the suctioned surface, the degree of closure between the suction port of the suction pipe and the suctioned surface, a clogging degree of the filter, an airflow velocity, and a suction force condition of the suction unit may be determined according to the characteristics of the sound signal, and a control host controls the suction force of the suction unit or adjusts the degree of closure between the suction port of the suction pipe and the suctioned surface accordingly, wherein the characteristics of the suctioned surface may, for example, include the material of the suctioned surface. Further, the suction force of the suction unit may be controlled or the degree of closure between the suction port of the suction pipe and the suctioned surface may be adjusted according to a comparison result between multiple preset sound characteristics and the characteristics of the sound signal obtained at that time, wherein different preset sound characteristics may include, for example, sound characteristics corresponding to different suctioned surfaces, sound characteristics corresponding to the suction force conditions of different suction units, sound characteristics corresponding to the filter with different clogging degrees, sound characteristics corresponding to the motor with different rotational speeds, sound characteristics corresponding to the rolling unit contacting different suctioned surfaces when rolling, sound characteristics corresponding to the moving wheel rotating on different suctioned surfaces, and other sound characteristics that may be caused when the suction device operates.

In summary, the detecting device of the embodiment of the disclosure may collect the sound generated when the suction device executes the suction operation, so as to obtain the characteristics of the sound signal, and determine the suction force of the suction unit, the clogging degree of the filter, the airflow velocity, and the degree of closure between the suction port of the suction pipe and the suctioned surface according to the characteristics of the sound signal. The control host may adjust the suction force of the suction device or the degree of closure between the suction port of the suction pipe and the suctioned surface according to the detected result of the detecting device, so as to effectively improve the suction efficiency of the suction device and improve the working efficiency of the rolling unit to reduce power consumption.

What is claimed is:

1. A suction device, comprising:
a suction pipe;
a suction unit, connected to the suction pipe and providing a suction force in the suction pipe to suction a suctioned surface;
a detecting device, collecting sound generated when the suction unit executes a suction operation, and generating a detected result according to a characteristic of a sound signal obtained by sound collection; and
a control host, coupled to the suction unit and the detecting device, and controlling the suction force of the suction unit or adjusting a degree of closure between a suction port of the suction pipe and the suctioned surface according to the detected result.

2. The suction device according to claim 1, wherein the detecting device determines a characteristic of the suctioned surface, the degree of closure between the suction port of the suction pipe and the suctioned surface, and a suction force condition of the suction unit according to the characteristic of the sound signal to generate the detected result, and the control host controls the suction force of the suction unit or adjusts the degree of closure between the suction port of the suction pipe and the suctioned surface according to at least one of the characteristic of the suctioned surface, the degree of closure between the suction port of the suction pipe and the suctioned surface, and the suction force condition of the suction unit.

3. The suction device according to claim 2, wherein the characteristic of the suctioned surface comprises a material of the suctioned surface.

4. The suction device according to claim 1, wherein the characteristic of the sound signal comprises at least one of sound of air flowing through the suction pipe, sound of air flowing through a gap between the suction port of the suction pipe and the suctioned surface, and sound of the suction unit operating.

5. The suction device according to claim 1, further comprising:
a rolling unit, contacting the suctioned surface and rolling; and
a moving wheel, wherein the characteristic of the sound signal comprises sound of a motor driving the rolling unit operating, sound when the rolling unit contacts the suctioned surface and rolls, and sound of the moving wheel rotating on the suctioned surface, and the control host controls at least one of a rolling speed of the rolling unit, a rolling direction of the rolling unit, a degree of fit between the rolling unit and the suctioned surface, and rotation of the moving wheel according to the detected result.

6. The suction device according to claim 1, further comprising:
a storage unit, coupled to the detecting device and storing a plurality of preset sound characteristics, wherein the detecting device compares the preset sound characteristics with the obtained characteristic of the sound signal to generate the detected result, and the control host controls the suction force of the suction unit or adjusts the degree of closure between the suction port of the suction pipe and the suctioned surface according to the detected result.

7. The suction device according to claim 6, further comprising:
a filter, disposed on an exhaust vent of the suction unit, wherein the characteristic of the sound signal comprises at least one of sound of air flowing through the suction pipe, sound of air flowing through the filter, and sound of the suction unit operating, the detecting device determines a clogging degree of the filter, an airflow velocity in the suction pipe, and a suction force condition of the suction unit according to a comparison result between the preset sound characteristics and the characteristic of the sound signal to generate the detected result, and the control host further controls the suction force of the suction unit or adjusts the degree of closure between the suction port of the suction pipe and the suctioned surface according to at least one of the clogging degree of the filter, the airflow velocity in the suction pipe, and the suction force condition of the suction unit.

8. The suction device according to claim 7, wherein the control host further provides warning information for cleaning or replacing the filter according to the clogging degree of the filter.

9. The suction device according to claim 1, wherein the detecting device comprises a sound collecting unit disposed in the suction pipe, and the sound collecting unit is a microphone or a microphone array.

10. The suction device according to claim 1, wherein the detecting device further adjusts an interval period of sound collection by the detecting device, a sampling frequency of sound collection, and a sampling time length of sound collection each time according to a working parameter of the suction unit.

11. A suction force adjustment method of a suction device, wherein the suction device comprises a suction unit and a suction pipe, and the suction unit is connected to the suction pipe and provides a suction force in the suction pipe to suction a suctioned surface, the suction force adjustment method of the suction device comprising:
collecting sound generated when the suction device executes a suction operation, and generating a detected result according to a characteristic of a sound signal obtained by sound collection; and
controlling the suction force of the suction unit or adjusting a degree of closure between a suction port of the suction pipe and the suctioned surface according to the detected result.

12. The suction force adjustment method of the suction device according to claim 11, comprising:
determining a characteristic of the suctioned surface, the degree of closure between the suction port of the suction pipe and the suctioned surface, and a suction force condition of the suction unit according to the characteristic of the sound signal to generate the detected result, and controlling the suction force of the suction unit or adjusting the degree of closure between the suction port of the suction pipe and the suctioned surface according to at least one of the characteristic of the suctioned surface, the degree of closure between the suction port of the suction pipe and the suctioned surface, and the suction force condition of the suction unit.

13. The suction force adjustment method of the suction device according to claim 12, wherein the characteristic of the suctioned surface comprises a material of the suctioned surface.

14. The suction force adjustment method of the suction device according to claim 11, wherein the characteristic of the sound signal comprises at least one of sound of air flowing through the suction pipe, sound of air flowing through a gap between the suction port of the suction pipe and the suctioned surface, and sound of the suction unit operating.

15. The suction force adjustment method of the suction device according to claim 11, wherein the suction device further comprises a rolling unit and a moving wheel, and the characteristic of the sound signal comprises sound of a motor driving the rolling unit to roll operating, sound when the rolling unit contacts the suctioned surface and rolls, and sound of the movement wheel rotating on the suctioned surface, the suction force adjustment method of the suction device comprising:
controlling at least one of a rolling speed of the rolling unit, a rolling direction of the rolling unit, a degree of fit between the rolling unit and the suctioned surface, and rotation of the moving wheel according to the detected result.

16. The suction force adjustment method of the suction device according to claim 11, comprising:
controlling the suction force of the suction unit or adjusting the degree of closure between the suction port of the suction pipe and the suctioned surface according to a comparison result between the preset sound characteristics and the characteristic of the sound signal.

17. The suction force adjustment method of the suction device according to claim 11, comprising:
adjusting an interval period of sound collection, a sampling frequency of sound collection, and a sampling time length of sound collection each time according to a working parameter of the suction unit.
